(19) United States
(12) Patent Application Publication
(10) Pub. No.: US 2007/0284382 A1
(43) Pub. Date: Dec. 13, 2007

(54) Pancake pan insert member

(76) Inventor: Fletcher Morgan, St. Petersburg, FL (US)

Correspondence Address: JOHN S. HALE;GIPPLE & HALE, 6665-A OLD DOMINION DRIVE, MCLEAN, VA, 22101, US

(21) Appl. No.: 11/449,844

(22) Filed: Jun. 9, 2006

(51) Int. Cl. A47J 27/00

(52) U.S. Cl. 220/912

(57) ABSTRACT

An insert member for a pancake cooking pan which can be turned during the cooking process for cooking foods such as pancakes and omelets that begin in liquid form and then are solidified during the cooking process. The insert member having a cooking body made of a heat conductive material and formed with a central flat bottom portion; a curved side wall extending upward from the bottom portion, a handle mounted to the cooking body and extending outward from one side of the cooking body. A mounting assembly is secured to the cooking body opposite from the handle and extending from the cooking body. The mounting assembly being adapted to be mounted to a rod extending between hinges of an existing pancake cooking pan and comprising a planar extension member and a U shaped channel member mounted on the distal end of the planar extension member.

### RELATED APPLICATIONS

There are no related applications.

### STATEMENT REGARDING FEDERALLY SPONSORED RESEARCH OR DEVELOPMENT

Not applicable.

### REFERENCE TO SEQUENCE LISTING, A TABLE OR A COMPUTER PROGRAM LISTING COMPACT DISC APPENDIX

None.

### FIELD OF THE INVENTION

The present invention generally to an insert member for a cooking pan which can be rotated 180° during the cooking process of cooking pancakes and omelets on a conventional stove burner and more specifically to an insert member for a pancake cooking pan having a pan section with a flat handle extending from one side and a pivot member extending from the other side, the pivot member being mounted to a hinge connector rod of an existing pancake cooking pan.

### BACKGROUND OF THE INVENTION

The cooking of food products that start from a liquid batter (such as pancakes and omelets) and subsequently solidify during the cooking process traditionally require that during the cooking process, the cook use a hand-held spatula, that must be inserted between the partially cooked food and the pan to turn over the food product so that the food product can be cooked on both sides. The action of the spatula sometime causes tearing of the finished product so that it does not have the desired appearance or ruins the presentation of the dish. Furthermore, such a cooking procedure makes it difficult to obtain a final cooked product which can be filled with another food component or filling such as whipped cream, sauces, fruit, nuts or the like unless the flat pancake or omelet is rolled which generally causes breaking and tearing of the finished product. Cooking pancakes or omelets requires constant monitoring of the pancake or omelet liquid and some agility on the part of the cook in turning over the food with a spatula with an additional step required once the cooking is complete, in that the food product must be carefully removed with a spatula from the concave pan to a plate for serving. Often the food product is much larger than the spatula, providing an opportunity for the food product to break apart during transfer. Because of the concave nature of typical cooking pans, the cook must insert a spatula below the cooked material and carefully remove the cooked product from the pan by moving the food over the concave side of the pan for serving the food. Because of the nature of cooking of these food product it is difficult to create a finished product which can be filled with another food filling. It is also important to have a high-quality cooking pan in which heat is transferred uniformly throughout the conductive heat surface and the use of iron skillets, aluminum, or copper pans for accomplishing same is well known. Currently manufactured pans often include a non-stick coating on the top surface of the metal pan known under the trademark of TEFLON. The pan cooking surfaces are coated to prevent sticking of eggs or pancake batter to the pan thus allowing easier spatula entry and to allow easier cleaning of the pans.

The prior art discloses several different approaches to the uniform cooking of pancakes, griddlecakes or omelets with an attempt to alleviate human frailty with a hand-held spatula in the cooking process.

The present invention overcomes the problems of the prior art by providing a pan insert member for a currently existing cooking pan for cooking pancakes, omelets and other food articles that require turning over during cooking and that begin as a liquid and firm up to be a solid or partial solid when the cooking process has been completed. The present invention is constructed for use with commercially available pancake cooking pans having a two heat-conductive cooking surfaces; one a concave section and the other a flat section. Both pan sections are hinged together with spaced apart hinges which are connected by a round rod. Both pan sections also have handles which when the pan is closed operate as a single handle. The initial food in liquid form is poured into a flat bottom surface of the concave section of the pancake pan and the inventive insert member is placed in the pancake cooking pan so that the bottom surface of the pan section of the insert member engages the liquid in the concave section of the pancake pan forming a depression in the cooked product. Once the cooked material solidifies sufficiently, the entire pan can be flipped 180°. The cooked material now rests on the flat cooking surface of the bottom of the insert member and the flat section of the cooking pan until cooking is complete. The cooked food can than easily be removed by opening the pan via its hinges and transferred to a plate by gravity without having to use a spatula with the resultant product being formed with a depression or reservoir which can hold a filling or another cooked product.

An early cooking appliance with a reversible grill is disclosed in U.S. Pat. No. 4,011,431 issued Mar. 8, 1977 which has a flat section and a concave section which are hinged together.

A current commercial pancake cooking pan is shown in U.S. Pat. No. 6,539,844 issued Apr. 1, 2003 which discloses a first concave cooking container that is joined by spaced hinges to a flat cooking body, both the container and cooking body having parallel handles which function as a single handle that allow the pan to be rotated 180 degrees during the cooking process. The final cooked food product can slide by gravity from the flat cooking body without a spatula. Another similar cooking pan is shown in U.S. Pat. No. 6,681,683 issued Jan. 27, 2004 which also has hinged flat and concave cooking bodies with the hinge brackets being joined by a bar with a circular cross section. Yet another cooking pan with a flat cooking surface is shown in U.S. Pat. No. 6,550,374 which issued Apr. 22, 2003. This cooking pan includes a first cooking container having three circular cooking wells for cooking three pancakes simultaneously that is joined by a hinge to a flat cooking body having a parallel handle to that of the other cooking container so that the device can be rotated 180 degrees during the cooking process.

### SUMMARY OF THE INVENTION

An insert member for use with a cooking pan for cooking pancakes, omelets, or other liquid foods that can be solidified and that require turning over during the cooking process, the insert member forming a reservoir in the final cooked product to hold a food filling or added food product. The insert member has a pan section with a curved side wall and a flat circular bottom surface. One side of the pan section is provided with a flat handle which fits between the two parallel handles of the existing pancake cooking pan and the other side of the pan section has a pivot member which extends away from the sidewall and is mounted over the hinge bar of an existing pancake cooking pan. The pan section has heat conductive cooking surfaces with a protective non-stick coating on both the outer surface portion and the inner surface and a flat handle connected to one edge of the sidewall. A pivot member extends from the front of the insert pan section opposite the handle and is mounted around the hinge bar of the existing pancake cooking pan. The flat handle fits between the two parallel handles of the existing pancake cooking pan.

It is an object of this invention to provide a cooking pan insert member for use in a pancake pan used for cooking liquids such as pancake batter or omelets that forms a reservoir in the cooked food product to receive and hold a food filling such as syrup, fruit, confectionary or cooked food.

It is another object of this invention to provide an insert member for a cooking pan for pancakes or omelets that at the completion of the cooking operation, the cooked foodstuff can slide from the pan without the use of hand-held spatulas.

It is still another object of the invention to provide a cooking pan insert member which can be easily manufactured and used by the end user.

It is yet another object of the invention to provide a cooking pan insert member which can be easily washed and cleaned.

It is another object of the invention to provide a cooking pan insert member which can be used on existing pancake cooking pans.

Still another object of the invention is to provide a cooking pan insert member that has one or more of the characteristics discussed above but which is relatively simple to use and requires a minimum of cooking skills.

The above and other objects, feature and advantages of the present invention will be apparent in the following detailed description thereof when read in conjunction with the appended drawings wherein the same reference numerals denote the same or similar parts throughout the several views.

### BRIEF DESCRIPTION OF THE DRAWINGS

The invention will be better understood and objects other than those set forth above will become apparent when consideration is given to the following detailed description thereof. Such description makes reference to the annexed drawings wherein.

FIG. 1 is a perspective view of the pancake pan insert member invention mounted in a standard pancake cooking pan;

FIG. 2 is a perspective view of the pancake pan insert member shown in FIG. 1 when the insert member is removed from the standard pancake cooking pan;

FIG. 3 is a plan view of the pancake pan insert member which is shown in FIG. 2; and

FIG. 4 is a side elevational view of the pancake pan insert member shown in FIG. 3.

### DETAILED DESCRIPTION OF THE INVENTION

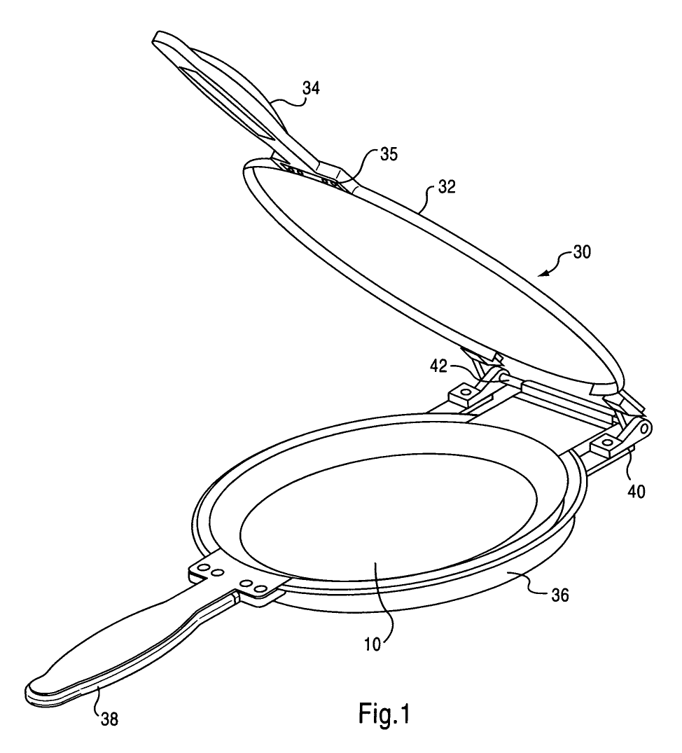

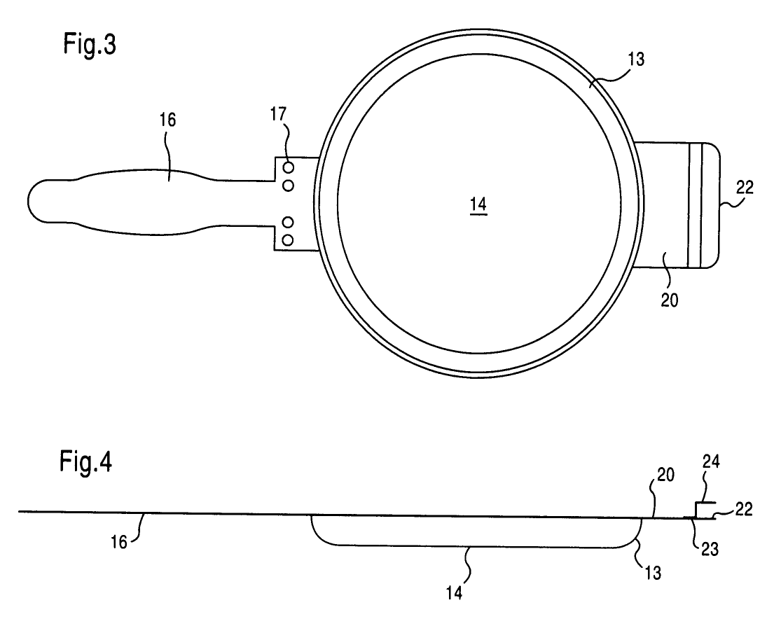

The preferred embodiment and best mode of the invention is shown in FIGS. 1 through 4. While the invention is described in connection with certain preferred embodiments, it is not intended that the present invention be so limited. On the contrary, it is intended to cover all alternatives, modifications, and equivalent arrangements as may be included within the spirit and scope of the invention as defined by the appended claims.

The present invention generally refers to the existing prior art as pancake pans throughout the application but this definition does not relate solely to pans for cooking pancakes but should be construed generally to those cooking pans used for cooking food which is initially is in a liquid or semi liquid-form which solidifies and conforms to the shape of the pan when cooked.

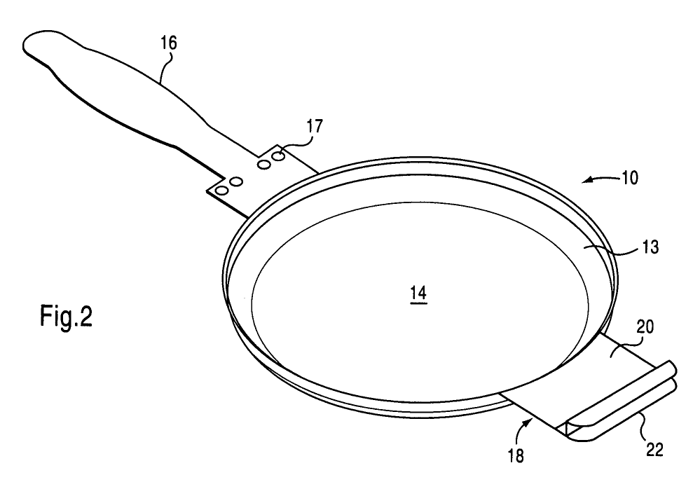

Referring now to the drawings and in particular FIGS. 1 and 2, the present invention is shown as a cooking insert member 10 that has a pan section 12 with a curved side wall 13 and a circular flat bottom surface 14, a flat surfaced ergonomically shaped handle 16 defining rivet holes 17 and a front pivot member 18. The front pivot member 18 is formed with a planar extension section 20 having one end secured to pan section 12 by welding or other means and the distal end formed with a U shaped channel section 22. The “U” shaped channel can be formed by welding a piece of metal with offset legs 23 and 24 as more clearly seen in FIG. 4 onto the upper surface of the planar extension section 20 or by securing a “U” shaped metal piece directly to the end of the extension member 20. The channel section 22 fits over a round hinge bar 42 extending between the hinges 40 of an existing standard pancake cooking pan 30. The top and bottom surfaces of the insert member 10 are preferably coated with one or more nonstick coatings, such as for example TEFLON®(i.e., fluorocarbon polymers), (e.g., tetrafluroethlene and fluorinated ethylene propylene). Alternately the insert member 10 can be constructed of sheet steel, stainless steel, copper, aluminum, cast iron, Pyrex®, glass, porcelain, ceramic or any type of microwaveable material at a uniform desired thickness commonly used for baking pans and containers. If desired, the flat handle 16 can be coated with or made of a thermal insulating material.

The prior art cooking pan 30 as shown in FIG. 1 is constructed of two sections, a flat, thin, circular, disk shaped section 32 which is made of a heat conductive metal such as aluminum which has a handle 34 attached to the flat section body by a plurality of rivets 35 and a concave pan section 36 which has an integral or rivet attached handle 38. Both pan sections 32 and 36 are pivotally mounted together by a pair of spaced hinges 40. The hinges 40 are connected together and supported by an elongated rigid rod 42 having a circular diameter. The flat pan handle 34 is positioned adjacent the concave pan handle 38 when the pan sections are closed for cooking to allow easy grasping by the user. The flat handle 16 of the insert member is positioned between handles 34 and 38 with the axis of all three handles being parallel. The rivet holes 17 of the insert member handle 16 seat the rivet heads of the associated rivets in handles 34 and 38.

In operation the liquid of the pancake batter or the eggs is placed in the concave pan 36 of the pancake cooking pan 30. The insert member 10 is mounted around the hinge rod 42 with the hinge rod 42 being seated in the U shaped channel of channel section 26 formed at the distal end of the extension member 20. The insert member handle 16 is then laid against the upper surface of handle 38 with the bottom flat surface 14 of the pan section 12 extending into the concave pan section and engaging the cooking liquid in the concave pan 36. The insert member 10 and cooking pans sections 32 and 36 together cook the batter or liquid mixture so that a depression or reservoir is formed in the cooked product. This depression or reservoir will have the same general dimensions and shape as the pan section 12. When the food product is fully cooked, the cooking pan 30 is opened on its hinges 40 and the inset member 10 removed with the cooked food positioned on the bottom surface 14 of the pan section 12, it being noted that pan section 12 is now the supporting structure. The cooked food is then removed to a serving tray or plate leaving a cooked product with a depression or reservoir into which a filling material can be later added.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What I claim is:

1. An insert member for a pancake cooking pan food used for cooking foods that begin in liquid form and then are solidified during the cooking process, comprising; a cooking section made of a heat conductive material that includes a central flat bottom portion and a side wall; a handle integrally formed with said cooking section and extending from one side of said side wall, a mounting assembly secured to said cooking section and extending from said cooking section, said mounting assembly being adapted to be mounted to a rod extending between hinges of an existing cooking pan.

2. An insert member as claimed in claim 1 wherein said cooking section is thermally conductive and includes a surface coating that provides a non-stick cooking surface while cooking.

3. An insert member as claimed in claim 1 wherein said handle is flat.

4. An insert member as claimed in claim 1 wherein said cooking section has a circular flat bottom and a curved side wall.

5. An insert member as claimed in claim 1 wherein said mounting assembly comprises a planar extension member and a U shaped channel member formed on the distal end of said planar extension member.

6. An insert member as claimed in claim 2 wherein said nonstick coating is tetrafluroethlene

7. An insert member as claimed in claim 1 wherein said nonstick coating is fluorinated ethylene propylene

8. An insert member as claimed in claim 3 wherein said handle defines a plurality of holes therethrough.

9. An insert member as claimed in claim 5 wherein said U shaped channel member comprises a portion of said extension member and an angled member with legs extending in opposite directions secured to said extension member.

10. An insert member for a pancake cooking pan which can be turned during the cooking process for cooking foods such as pancakes and omelets that begin in liquid form and then are solidified during the cooking process, comprising; a cooking body made of a heat conductive material that includes a central flat bottom portion; a curved side wall extending upward from said bottom portion, a handle secured to said cooking body and extending outward from one side of said cooking body, a mounting assembly secured to said cooking body and extending outward from said cooking body, said mounting assembly being adapted to be mounted to a rod extending between hinges of an existing pancake cooking pan, said mounting assembly comprising a planar extension member and a U shaped channel member mounted on the distal end of said planar extension member.

11. An insert member as claimed in claim 10 wherein said flat cooking body is thermally conductive and includes a surface coating that provides a non-stick cooking surface while cooking.

12. An insert member as claimed in claim 10 wherein said handle is flat.

13. An insert member as claimed in claim 10 wherein said cooking body has a circular flat bottom.

14. An insert member as claimed in claim 11 wherein said nonstick coating is tetrafluroethlene.

15. An insert member as claimed in claim 11 wherein said nonstick coating is fluorinated ethylene propylene.

16. An insert member as claimed in claim 12 wherein said handle defines a plurality of holes.

17. An insert member as claimed in claim 10 wherein said U shaped channel member comprises a position of said extension member and an angled member with legs extending in opposite directions secured to said extension member.

18. An insert member for a pancake cooking pan which can be turned during the cooking process for cooking foods such as pancakes and omelets that begin in liquid form and then are solidified during the cooking process, comprising; a cooking body made of a heat conductive material and comprising a circular flat bottom portion; a curved side wall extending upward from said bottom portion, a handle secured to said side wall extending outward from one side of said cooking body, a mounting assembly secured to said side wall and extending outward from said cooking body, said mounting assembly being adapted to be mounted to a cylindrical rod extending between hinges of an existing pancake cooking pan, said mounting assembly comprising a planar extension member with a channel member mounted on the distal end of said planar extension member having a channel of a width greater than the diameter of said cylindrical rod.

19. An insert member as claimed in claim 18 wherein said flat cooking body is thermally conductive and includes a surface coating that provides a non-stick cooking surface while cooking.

20. An insert member as claimed in claim 18 wherein said handle is coated with insulating material.
